(19) United States
(12) Patent Application Publication
(10) Pub. No.: US 2002/0098322 A1
(43) Pub. Date: Jul. 25, 2002

(54) Anti-erosion irrigation mat

(76) Inventor: Eric E. Cripp, Reno, NV (US)

Correspondence Address: J. E. McTaggart, 1860 Eastman Ave. Suite 105, Ventura, CA, 93003, US

(21) Appl. No.: 09/766,172

(22) Filed: Jan. 22, 2001

(51) Int. Cl. B32B 5/02

(52) U.S. Cl. 428/132; 428/136; 442/104

(57) ABSTRACT

An anti-erosion irrigation mat is fitted with parallel runs of drip line irrigation tubing and delivered in panels or rolls that can installed in a single operation instead of the two separate operations conventionally required for erosion prevention and irrigation. The drip line tubing runs are fitted with drip emitters at uniform intervals and are attached to the matting which may be made biodegradable for short term service, e.g. from biodegradable natural fibers, or made durable, e.g. from nylon filaments. The components of the invention, i.e. anti-erosion matting and irrigation drip lines, are commercially available. The low velocity of drip irrigation applies water through a grid pattern of drip emitters with a minimum of surface erosion that is well controlled by the matting. In addition to the time and cost savings from reducing the installation to a single operation, there are additional cost savings from simplification of the original system design effort.

### FIELD OF THE INVENTION

The present invention relates to the fields of irrigation and soil erosion prevention, more particularly it relates to a unified system and related implementation products that combine a drip line irrigation system and anti-erosion matting for design and installation efficiency and cost savings.

### BACKGROUND OF THE INVENTION

Systems for irrigation and for erosion prevention have traditionally been practiced largely independently of each other; each has developed and evolved working systems for field deployment that are dedicated to the respective fields and that are each customarily installed in separate operations at different times.

Anti-erosion measures required following manmade disturbance or natural failure of a sloping ground region, or drainage channel, leaving it unstable and vulnerable, typically involve subsoil compaction followed by establishing new ground cover growth at the surface to help prevent erosion, particularly in the event of heavy rainfall. The holding ability of the roots of such vegetation can be greatly enhanced by reinforcing it with a suitable matting. Typically this matting is laid, and pinned on the compacted subsoil and covered by topsoil to be seeded. The matting reinforcement can be made of biodegradable material as a temporary measure to allow time for the vegetation to become rooted, or it can be of relatively permanent material to provide ongoing surface reinforcement in conjunction with the vegetation roots.

It is usually necessary to provide some kind of irrigation, at least a temporary system to expedite the initial growth and rooting of newly planted vegetation; in most instances, depending on regional climate, a permanent irrigation system is usually installed to provide ongoing watering to sustain the vegetation through dry seasons.

There are two main types of irrigation systems: sprinklers and drip types. The sprinkler type has two main disadvantages: (1) being fed from a system of pipe lines buried underground, they usually require potentially de-stabilizing trenches to be cut into the compacted subsoil, and (2) sprinklers have a precipitation rate that is much higher than that of drip lines, thus sprinklers require very close regulation and supervision to prevent serious de-stabilization from accidental over-watering, especially during the period of seed germination.

The drip line systems utilize parallel runs of flexible plastic tubing, typically made from polyethylene, fitted at regular intervals with drip apertures such as water emitters or tiny holes, usually laser drilled: both the tubing and the emitters are widely available commercially.

Erosion control matting products come in various forms ranging from a temporary grade with biodegradable natural fibers to a durable grade, e.g. woven from high tensile strength nylon filaments and formed into an open porous mat typically ranging in thickness between ½″ and ¾″. Such products are commercially available, e.g. under the trade name TRM (Turf Reinforcement Matrix).

Typically the irrigation system and the anti-erosion system require two distinctly separate design tasks; furthermore they must be installed in separate operations and in different time frames, often with some degree of conflict or even rework required, incurring corresponding cost and time burdens.

### DISCUSSION OF KNOWN ART

Erosion control mats and blankets have been disclosed in many U.S. Pat. Nos. including 5,786,281 and 5735,982 EROSION CONTROL BLANKET AND METHOD OF MANUFACTURE, 5,249,893 and 4,135,843 EROSION CONTROL MAT, 4,889,446 and 4,690,585 EROSION CONTROL FOUNDATION MAT AND METHOD. The foregoing patents are typical of the known art in that they address only erosion control, with no teaching or suggestion of incorporating irrigation capability.

In the inventor's specialized field of landscape architecture, where a professional takes responsibility for performance and cost effectiveness of both erosion prevention and irrigation and for resolving their conflicting requirements, it came to be recognized that a unified approach could yield benefits of simplification, time savings and cost reduction both in design and in actual installation operations.

### OBJECTS OF THE INVENTION

It is a primary object the present invention to provide a unified approach to erosion prevention and irrigation that is more efficient and cost effective than the conventional independent approaches to these two requirements.

It is a further object to simplify, expedite and facilitate the original design, development and specification activity requirements for irrigation/erosion prevention projects.

It is a further object to provide a single unified product that can be implemented and installed in a single operation instead of the conventional practice of performing separate erosion prevention and irrigation operations for the same region.

It is a further object to provide a product that performs both irrigation and erosion prevention simultaneously, and that can be readily installed as a single combined product in a single unified operation.

### SUMMARY OF THE INVENTION

The abovementioned objects have been accomplished in the present invention of an anti-erosion irrigation mat fitted with drip line irrigation tubing and that can be delivered and installed in flat panels or in long strips packaged in rolls. The tubing is fitted in parallel lines with drip emitters at uniform intervals and is interwoven or otherwise attached to standard anti-erosion matting that may be procured as biodegradable for temporary for short term service, e.g. made from natural fibers, or as durable and relatively permanent, e.g. from nylon filaments. The three major components of the anti-erosion matting, i.e. the tubing, the drip emitters and the anti-erosion matting, are all commercially available.

The low velocity of drip irrigation applies water with a minimum of surface erosion, and this is well controlled by the matting.

### BRIEF DESCRIPTION OF THE DRAWINGS

The above and further objects, features and advantages of the present invention will be more fully understood from the following description taken with the accompanying drawings in which:

FIG. 1 is a plan view of a portion of a typical anti-erosion irrigation mat according to the present invention.

FIG. 2 is a cross-section taken through 2-2′ of FIG. 1, showing the mat installed on a sloping ground region.

FIG. 3 is a plan view of the portion of anti-erosion irrigation mat of FIG. 1 shown installed between adjacent similar mats, shown in part.

### DETAILED DESCRIPTION

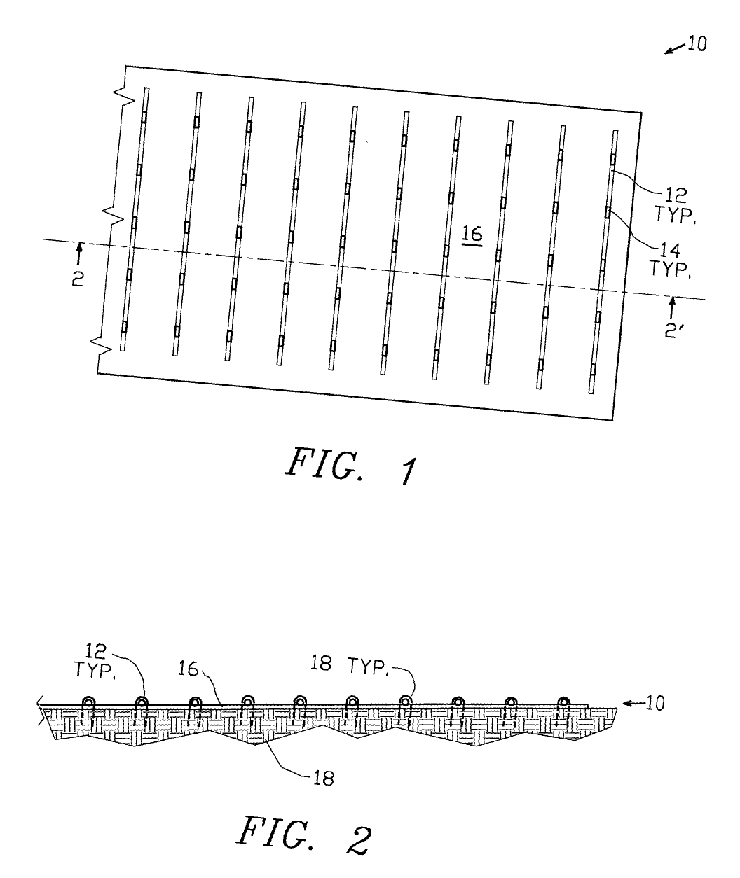

FIG. 1 is a plan view of an anti-erosion irrigation matting panel 10 according the present invention, based on standard anti-erosion matting material 16 to which are attached drip lines 12 arranged in a uniform array as shown, each extending transversely across panel 10.

Drip lines 10 are commercially available as standard irrigation hardware in the form of flexible plastic tubing fitted with a series of drip emitters 14. These can be implemented simply as laser-cut apertures or as special, pressure-compensating emitter inserts pre-installed in the tubing spaced at regular intervals, typically 12 to 18 inches apart.

The drip lines 12 are each attached, or woven into to the anti-erosion matting material 16, extending substantially across panel 10 in a parallel array as shown, typically spaced 12 to 18 inches apart, thus providing a panel 10 that is pre-assembled with the emitters 14 arranged in a square or triangular grid pattern for uniform water distribution.

Various grades of anti-erosion mat material are commercially available ranging from biodegradable natural fiber material intended for short-term service, for example just long enough to get new vegetation started, to plastic materials such as nylon filaments or molded cells intended for prolonged service. Such materials are commercially available, for example under the trade name TRM (Turf Reinforcement Matrix). Typical anti-erosion matting is ½ inch to ¾ inch thick.

Typically the panel width, as indicated in FIG. 1 by the vertical extent of panel 10, is made to be 8 feet, a common width of commercially available anti-erosion matting material. Panel 10 can be fabricated in any suitable length as an individual square or rectangular panel; however for efficiency in larger projects panel 10 can be fabricated including the drip line tubing runs, as a continuous strip, rolled and cut to suitable length, e.g. 80 to 100 feet, that will allow transportation to the project site. The rolls would typically be placed at an uphill location corresponding to the right hand side of FIG. 1 and unrolled downhill onto the target region, i.e. toward the left in FIG. 1.

FIG. 2, a cross-section taken through 2-2′ of FIG. 1 shows the anti-erosion irrigation panel 10 installed on a region of sloping ground 18. Drip lines 12 are seen in end view on the upper surface of the anti-erosion matting 16. At the completion of installation of the anti-erosion irrigation mat made up of panels 10 as shown, this upper surface would normally be pinned to the graded surface, e.g. with soil staples 18, covered with a layer of topsoil and seeded with ground cover vegetation, then irrigated, at least sufficiently to get growth started.

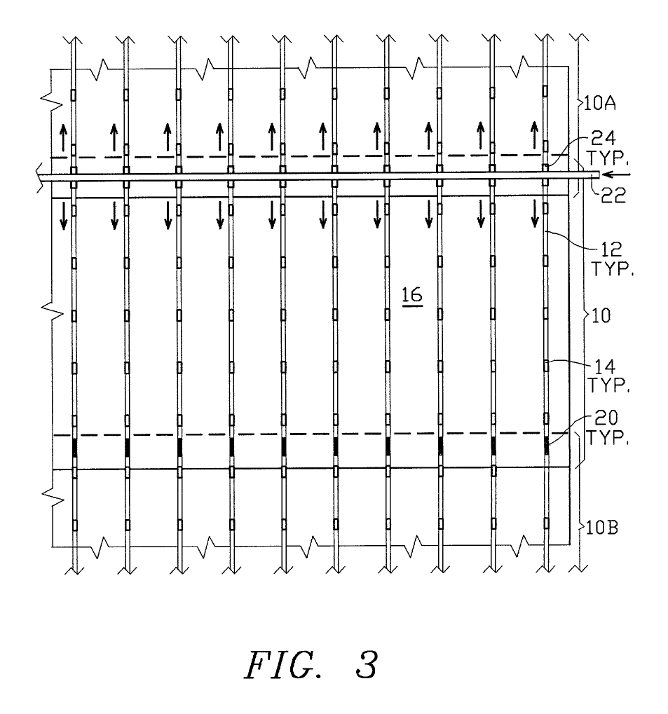

FIG. 3 is a plan view of a portion of an anti-erosion irrigation matting utilizing a plurality of panels as in FIG. 1. Panel 10 is shown installed and interconnected between two similar panels 10A and 10B: a corner portion of each is shown.

At the overlapping panel interface near the bottom of FIG. 3, drip lines 12 of the central panel 10 are connected to the corresponding drip lines of the adjacent panel 10B via plastic coupling connectors 20 of a conventional type wherein a pair of oppositely-facing barbed nozzles are inserted in a push-in manner into the interfacing open tubing ends of the drip lines 12.

At the overlapping panel interface near the top of FIG. 3, a manifold pipeline 22, receiving water from a valved water supply source indicated by the horizontal arrow, is fitted with connectors 24 on both sides so as to provide interconnection to the drip lines 12 of the two adjacent overlapping panels 10 and 10A, for water flow as indicated by the vertical arrows.

Manifold pipeline 22 can be made as long as required for the size of the project as long as the length doesn't exceed the flow capacity of the pipeline: further panel extensions may be added in the downhill direction, with the ends overlapped in the same manner shown for the edges in FIG. 1. At these overlapping interfaces. If one of the panels is located generally higher in elevation than the adjacent one, the overlapping edge of the higher panel should always be placed on top of the adjacent panel edge so as to prevent lifting or other disturbance by any unusual water or mud flow.

As an alternative to locating the manifold pipeline 22 at the interface between two panels, it could be located at a boundary of the project area, and fitted with connector 24 along one side only, feeding only one side of a bordering panel.

Typically the manifold pipeline 22 is made from one inch PVC (polyvinyl chloride) stock and the drip lines 12 are tubing of a softer plastic such as polyethylene with ½″ or ¾″ inside diameter. The final ends of manifold pipeline 22 and drip lines 12 at the boundaries of the project are stopped with flush end plugs fitted in a conventional manner The anti-erosion irrigation system is highly flexible for accommodating uneven terrain by varying the amount of overlap at the edges of panels 10. The drip lines 12 and manifold lines 22 being of standard material, are easily customized to suit individual sites and requirements.

Optionally, the drip lines 12 could be located on the bottom side of the mat material 16 instead of on the top side as shown. This could be beneficial, for example, in the case of lining a channel that is subject to heavy water drainage.

Attachment of the irrigation drip line 12 to the anti-erosion matting 16 may be implemented by any of a number of different fastening methods, e.g. plastic or metal tie members encompassing the drip line and a portion of the matting, spiral lacing, spring clips or coils, adhesives, interweaving of the drip line with the matting material 16. A further option would be an integrated manufacturing process by which the matting material 16 and the drip line 12, including the drip emitters 14, would be formed together in the manufacturing process.

The principle of the invention, i.e. attaching irrigation lines to reinforcement matting and installing them in a single operation, is of such a basic nature that it could be practiced with many different materials, configurations and physical dimensions as alternatives to those shown and described above, depending on local conditions and requirements.

As an alternative to the square grid pattern of emitters 14 as shown, the system could be dimensioned and arranged to provide alternative array patterns, for example, a triangular pattern or a square pattern rotated 45 degrees from the square pattern shown.

This invention may be embodied and practiced in other specific forms without departing from the spirit and essential characteristics thereof. The present embodiments therefore are considered in all respects as illustrative and not restrictive. The scope of the invention is indicated by the appended claims rather than by the foregoing description. All variations, substitutions, and changes that come within the meaning and range of equivalency of the claims therefore are intended to be embraced therein.

What claimed is:

1. An anti-erosion irrigation mat comprising:
a reinforcing mat of open porous structure, having a generally rectangular shape defined by a width and a length;
a row of drip pipe lines disposed in a parallel array, each drip pipe line extending substantially across the width of said reinforcing mat, each of said drip pipe lines including a series of drip emitters installed therein: and
attachment means made and arranged to attach said drip pipe lines to said reinforcing mat at predetermined locations thereon.

2. The anti-erosion irrigation mat as defined in claim 1 wherein said drip pipe lines are located so as to be separated uniformly by a predetermined nominal dimension.

3. The anti-erosion irrigation mat as defined in claim 2 wherein the drip emitters are located in said drip pipe lines so as to be separated uniformly by the predetermined nominal dimension.

4. An anti-erosion irrigation mat system comprising an array of anti-erosion irrigation mats each comprising:
a reinforcing mat of open porous structure, having a generally rectangular shape defined by a width and a length; and
a row of drip pipe lines disposed in a parallel array, each drip pipe line extending substantially across the width of said reinforcing mat and attached thereto, each of said drip pipe lines including a series of drip emitters installed therein.

5. The anti-erosion irrigation mat as defined in claim 4 wherein said drip pipe lines are located so as to be separated uniformly by a predetermined nominal dimension.

6. The anti-erosion irrigation mat as defined in claim 5 wherein the drip emitters are located in said drip pipe lines so as to be separated uniformly by the predetermined dimension.

7. The anti-erosion irrigation mat as defined in claim 6 further comprising at least one manifold pipe line, connected to a source of irrigation water and fitted with an array of tubing connectors arranged to engage ends of corresponding drip pipe lines of at least one of said panels so as to connect the drip emitters therein in fluid communication with the source of irrigation water.

8. The anti-erosion irrigation mat as defined in claim 7 wherein said manifold pipe line is fitted with two rows of said tubing connectors, one on each opposite side thereof, for engaging corresponding drip pipe lines of two adjacent ones of said panels.

9. The anti-erosion irrigation mat as defined in claim 4 wherein, in said reinforcing mat, the width is made to be approximately eight feet and the length is made to be at least fifty feet, said reinforcing mat being packaged including said drip pipe lines in a roll for purposes of initial shipment and installation.

10. A method of installing anti-erosion matting and irrigation drip lines fitted with uniformly spaced drip emitters in a target area in a single installation operation instead of conventional separate installation operations for anti-erosion and irrigation, comprising the steps of:
(1) attaching a plurality of parallel runs of the irrigation drip lines to generally rectangular elongate panels of anti-erosion reinforcing matting in a designated pattern on each panel; and
(2) installing the panels in place in the target area side-by-side with tubing ends of the drip lines interconnected by conventional tubing connectors, and with irrigation-water-receiving manifolds connected to the drip lines as required.
